(19) United States
(12) Patent Application Publication
(10) Pub. No.: US 2013/0292333 A1
(43) Pub. Date: Nov. 7, 2013

(54) METHOD FOR SEPARATING AND RECOVERING PURIFIED ALKALI METAL SALT

(71) Applicants: Takao Sasaki, Otsu-shi (JP); Masahide Taniguchi, Otsu-shi (JP); Hiroo Takabatake, Otsu-shi (JP); Saburo Sone, Chuo-ku (JP)

(72) Inventors: Takao Sasaki, Otsu-shi (JP); Masahide Taniguchi, Otsu-shi (JP); Hiroo Takabatake, Otsu-shi (JP); Saburo Sone, Chuo-ku (JP)

(73) Assignee: TORAY INDUSTRIES, INC., Tokyo (JP)

(21) Appl. No.: 13/991,046

(22) PCT Filed: Dec. 1, 2011
(86) PCT No.: PCT/JP2011/077856

§ 371 Date: Jul. 25, 2013

(30) Foreign Application Priority Data
Dec. 1, 2010 (JP) 2010-268014

(51) Int. Cl. C01D 5/16

(52) U.S. Cl. CPC C01D 5/16
USPC 210/651

(57) ABSTRACT

The present invention relates to a method for separating and recovering a purified alkali metal salt from an aqueous alkali metal salt solution, the method including a treatment step of removing a purification-inhibiting substance from an aqueous alkali metal salt solution with a separation membrane having a glucose removal ratio and an isopropyl alcohol removal ratio simultaneously satisfying the following expressions (I) and (II) when each of a 1000 ppm aqueous glucose solution having a temperature of 25° C. and pH of 6.5 and a 1000 ppm aqueous isopropyl alcohol solution having a temperature of 25° C. and pH of 6.5 is permeated through the separation membrane at an operating pressure of 0.75 MPa: Glucose removal ratio≧90% . . . (I), Glucose removal ratio—Isopropyl alcohol removal ratio≧30% . . . (II).

### TECHNICAL FIELD

The present invention relates to a method for separating and recovering a purified alkali metal salt such as a purified lithium salt or a purified potassium salt from lake water, ground water, industrial wastewater, and the like and relates to a method for efficiently recovering a purified alkali metal salt by removing a purification-inhibiting substance using a separation membrane exhibiting a high selective permeation ability for a specific compound.

### BACKGROUND ART

Recently, a demand for mineral resources has remarkably expanded with global industrial and economical development. Among mineral resources indispensable for various industries including the semiconductor industry, there are resources which are technically difficult to take out as simple substances and are economically unreasonable owing to high costs for mining and refining even though the reserves in the earth's crust are large and many cases where the resources are localized to specific areas. On the other hand, environmental problems have also been highlighted and thus it is desired to construct a recycling society. In particular, since attention has been attracted in view of the reduction of carbon dioxide emissions, the development of electric automobiles and also motors and batteries used therein has been accelerated. Particularly, regarding the batteries, a lithium ion secondary battery is expected as a main battery for the electric automobiles owing to energy density and lightweight thereof.

As uses of lithium compounds, for example, lithium carbonate is used as an electrode material of lithium ion batteries and an additive for heat-resistant glass and also for elastic surface wave filters. In particular, highly pure one has been used as a filter and emitter for cell phones, car navigation systems, and the like. Uses of lithium bromide are coolant absorbers of absorption-type freezers for large air conditioners for building, factories, and the like, and uses of lithium hydroxide are grease for automobiles and the like and a raw material for lithium batteries (primary and secondary). Uses of metal lithium are the anode material of primary batteries and a raw material for butyllithium for synthetic rubber catalysts.

The lithium salts are contained in salt lake brines and ores, and resource recovery from the salt lake brines is advantageous in view of production costs. The salt lake brines are mainly present in Chili, Bolivia, and Argentina and the reserves thereof are also large. The brines are mainly classified into chloride brines, sulfate salt brines, carbonate salt brines, and calcium brines based on the composition. Of these, the sulfate salt brines that are richest in resource amount frequently form sparingly soluble salts from the sulfate salts in the process of purification or contain a large amount of alkaline earth metals. Thus, it was difficult to recover the salts efficiently as purified salts such as lithium carbonate.

As measures for solving the problem, various methods using adsorbents (Patent Documents 1 to 3) and the like have been proposed but a high cost is a problem, and a technology of steadily recovering a purified lithium salt at low costs is not established. As a conventional low-cost method, a method of removing impurities under concentration through sun drying of a brine may be mentioned but the method has a problem that the method is difficult to apply in the case where lithium concentration is low or in the case where concentration of alkaline earth metals is high. Furthermore, an electrodialysis process and a membrane filtration process are under investigation (Non-Patent Document 1) but are not put into practical use.

On the other hand, potassium that is also an alkali metal has been widely used in fertilizers and also foods, feeds, industrial chemicals, medicaments, and the like but producing countries are limited to Canada, Russia, Belarus, and the like. At present, although potassium does not have a serious resource problem, there is a concern about the tightness of the resource in view of steady supply of the fertilizer ingredient indispensable for food production and also with explosive population increase and economic growth in developing countries.

### BACKGROUND ART DOCUMENT

### Patent Document

Patent Document 1: JP-A-2009-161794
Patent Document 2: JP-A-2002-167626
Patent Document 3: JP-A-4-293541

### Non-Patent Document

Non-Patent Document 1: “Heisei 20 Nendo Genba Niizutou ni taisuru Gijutsu Shien Jigyo (Technical Assistant Project for Actual Spot Needs in 2008): Kansui karano Richiumu Kaisyu Sisutemu Kaihatsu ni kansuru Kyoudo Sutadei Houkokusho (Report on Cooperative Study Regarding Lithium Recovery System Development from Brine) (a version open to public)”, Incorporative Administration Agency Petroleum Natural Gas/Metal Mineral Resource Organization, Mitsubishi Corporation, March, 2010

### SUMMARY OF THE INVENTION

### Problems that the Invention is to Solve

An object of the invention is to provide a method for steadily recovering alkali metals such as lithium and potassium from lake water, ground water, industrial waste water, and the like at low costs.

### Means for Solving the Problems

In order to solving the above-mentioned problem, the present invention relates to the following constitutions.

(1) A method for separating and recovering a purified alkali metal salt from an aqueous alkali metal salt solution, the method including a treatment step of removing a purification-inhibiting substance from an aqueous alkali metal salt solution with a separation membrane having a glucose removal ratio and an isopropyl alcohol removal ratio simultaneously satisfying the following expressions (I) and (II) when each of a 1000 ppm aqueous glucose solution having a temperature of 25° C. and pH of 6.5 and a 1000 ppm aqueous isopropyl alcohol solution having a temperature of 25° C. and pH of 6.5 is permeated through the separation membrane at an operating pressure of 0.75 MPa:

Glucose removal ratio≧90% (I),

Glucose removal ratio−Isopropyl alcohol removal ratio≧30% (II).

(2) The method for separating and recovering a purified alkali metal salt according to item (1), in which a lithium ion concentration in the aqueous alkali metal salt solution falls within the range of 0.5 ppm or more to 10000 ppm or less.
(3) The method for separating and recovering a purified alkali metal salt according to item (1) or (2), in which a magnesium ion concentration in the aqueous alkali metal salt solution is 1000 times or less the lithium ion concentration.
(4) The method for separating and recovering of a purified alkali metal salt according to any one of items (1) to (3), which includes a step of mixing a part of the aqueous alkali metal salt solution with a permeated water formed by the treatment step.
(5). The method for separating and recovering a purified alkali metal salt according to any one of items (1) to (4), in which the purification-inhibiting substance in the aqueous alkali metal salt solution is removed and also lithium is concentrated by the treatment step.
(6) The method for separating and recovering a purified alkali metal salt according to any one of items (1) to (5), in which a concentrate of the alkali metal salt is performed after the treatment step.
(7) The method for separating and recovering a purified alkali metal salt according to any one of items (1) to (6), in which the treatment step is performed until the magnesium ion concentration in the aqueous alkali metal salt solution becomes 7 times or less the lithium ion concentration.
(8) The method for separating and recovering a purified alkali metal salt according to any one of items (1) to (7), in which the purification-inhibiting substance is at least one selected from the group consisting of a magnesium salt and a sulfate salt.
(9) The method for separating and recovering a purified alkali metal salt according to any one of items (1) to (8), in which an operation pressure of the membrane separation at the treatment step is osmotic pressure of the aqueous alkali metal salt solution or lower.

### Advantage of the Invention

According to the present invention, it becomes possible to efficiently recover alkali metals such as lithium and potassium from aqueous solutions in which various solutes are co-existed.

### MODE FOR CARRYING OUT THE INVENTION

The aqueous alkali metal salt solution of the invention is preferably a solution containing at least a lithium salt and, in a salt lake brine or the like to which the method of the invention is applied, compounds composed of salts of at least one metal of alkali metals such as sodium, potassium, rubidium, and cesium other than lithium, also alkaline earth metals such as magnesium, calcium, and strontium, typical elements (aluminum, tin, lead, etc.), and transition metals (iron, copper, cobalt, manganese, etc.), with one or more kinds of conjugate bases (e.g., chloride ion, nitrate ion, sulfate ion, carbonate ion, acetate ion, etc.) are dissolved. The concentration of each ingredient is not particularly limited and, from the view point of efficiency of separation and recovery, the lithium ion concentration is preferably falls within the range of 0.5 ppm or more to 10000 ppm or less, more preferably within the range of 5 ppm or more to 5000 ppm or less, and further preferably, it is preferred to use an aqueous solution having a lithium ion concentration ranging from 50 ppm or more to 2000 ppm or less as a raw water. If necessary, it is possible to provide the solution as raw water after treatment such as concentration or dilution.

Here, at the separation and recovery of desired purified alkali metal salt(s) such as lithium carbonate and/or potassium chloride, for example, as the purification-inhibiting substances, alkaline earth metal salts and sulfate salts which tend to form sparingly soluble salts, organic substances in the earth's crust, and the like may be mentioned, and magnesium salts, sulfate salts and/or the like may be exemplified. In the invention, from the viewpoint of efficiency of separation and recovery of the purified alkali metal salts from an aqueous alkali metal salt solution, the magnesium ion concentration in the aqueous alkali metal salt solution to be a raw water is preferably 1000 times or less the lithium ion concentration, and it is efficient when the concentration ratio is more preferably 500 times or less and further preferably 100 times or less.

In the invention, at the treatment step of removing the purification-inhibiting substances with a separation membrane, it is preferred to perform the removal treatment with the separation membrane until the magnesium ion concentration in the aqueous solution containing alkali metal salts becomes 7 times or less the lithium ion concentration in the aqueous solution. When the ratio exceeds 7 times, recovery efficiency of the purified alkali metal salt(s) remarkably decreases. In this regard, the weight of the purification-inhibiting substances was calculated as weight in terms of an ion such as magnesium ion or sulfate ion. Moreover, the weight in terms of lithium ion and the weight of the purification-inhibiting substances are determined by quantitative determination of concentrations of various ions in the aqueous solution containing alkali metal salts through ion-chromatographic measurement.

With regard to the content of the purification-inhibiting substances, the composition and concentration of the purification-inhibiting substances vary depending on the nature and properties of the raw water. For example, a salt lake brine contains magnesium ion and sulfate ion each in the range of 100 ppm or more to 30000 ppm or less.

The present inventors have found that, in the case where a nanofiltration membrane is used as a separation membrane, particularly by using a nanofiltration membrane having a glucose removal ratio of 90% or more and the difference between the glucose removal ratio and an isopropyl alcohol removal ratio of 30% or more when each of a 1000 ppm aqueous isopropyl alcohol solution of 25° C. and pH 6.5 and a 1000 ppm aqueous glucose solution of 25° C. and pH 6.5 is permeated through the membrane at an operating pressure of 0.75 MPa, separation of alkali metal salts, especially a lithium salt from the purification-inhibiting substances is achieved at extremely high efficiency, independent of total salt concentration. Thus, the invention has been accomplished.

In general, since the above purified alkali metal salt(s) can be separated and recovered by precipitation operations induced by concentration, heating, and/or cooling of the aqueous solution or addition of a nucleating agent, it is preferred to remove magnesium salts and/or sulfate salts which inhibit the operations. Therefore, by using a nanofiltration membrane having a magnesium sulfate removal ratio of 90% or more, preferably 95% or more, further preferably 97% or more and a lithium chloride removal ratio of 70% or less, preferably 50% or less, further preferably 30% or less when each of a 2000 ppm aqueous magnesium sulfate solution of 25° C. and pH 6.5 and a 2000 ppm aqueous lithium chloride solution of 25° C. and pH 6.5 is permeated through the membrane at an operating pressure of 0.75 MPa, separation of a lithium salt from the purification-inhibiting substances is achieved at extremely high efficiency, independent of total salt concentration. Moreover, it is preferred to recover the purified alkali metal salt(s) by concentration of the alkali metal salt(s) after the step with the separation membrane of the invention.

With regard to the recovery of the purified alkali metal salts, for example, in the case of a potassium salt, the recovery is performed by a known method where potassium chloride is recovered by utilizing temperature dependency of solubility or by adding a poor solvent such as ethanol. In the case of a lithium salt, it is recovered as lithium carbonate by adding a carbonate salt to the aqueous solution utilizing the fact that the solubility of lithium carbonate is small as compared with the other alkali metal salts. The recovery utilizes the fact that the solubility of lithium carbonate is only 1.33 g per 100 mL of water at 25° C. and the solubility further decreases at high temperature as compared with sufficiently high solubility in water of sodium carbonate and potassium carbonate (20 g or more per 100 mL of water).

The nanofiltration membrane herein is a membrane defined as a “pressure-driven membrane where particles and dissolved macromolecules smaller than 2 nm are rejected”. The nanofiltration membrane effective for the application to the invention is preferably one which has charge on the membrane surface and thus exhibits an improved separation efficiency particularly for ions by the combination of separation through fine pores (size separation) and electrostatic separation thanks to the charge on the membrane surface. Therefore, it is necessary to apply a nanofiltration membrane capable of removing polymers by the size separation simultaneously with separating the alkali metal ion to be a target for recovery from the other ions having different charge properties by the charge.

As materials of the nanofiltration membrane for use in the invention, polymer materials such as cellulose acetate-based polymers, polyamides, sulfonated polysulfones, polyacrylonitrile, polyesters, polyimides, and vinyl polymers may be used. The membrane is not limited to a membrane composed of only one kind of the material and may be a membrane containing a plurality of the materials. With regard to the membrane structure, the membrane may be an asymmetric membrane having a dense layer on at least one face of the membrane and having micropores whose pore size gradually increases from the dense layer to the inside of the membrane or another face or a composite membrane having a very thin functional layer formed of the other material on the dense layer of the asymmetric membrane. As the composite membrane, for example, use can be made of a composite membrane where a nanofilter composed of a polyamide functional layer is constructed on a supporting membrane using a polysulfone as a membrane material, as described in JP-A-62-201606.

Of these, preferred is a composite membrane having excellent potential including all of high pressure resistance, high water permeability, and high solute-removing performance and using a polyamide as a functional layer. In order to be able to maintain durability against operation pressure, high water permeability, and rejection performance, one having a structure where a polyamide is used as a functional layer and is held by a porous membrane with a support composed of a nonwoven fabric is suitable. Moreover, as the polyamide semi-permeable membrane, a composite semi-permeable membrane having on a support a functional layer of a crosslinked polyamide obtained by a polycondensation reaction of a polyfunctional amine with a polyfunctional acid halide is suitable.

Here, the polyfunctional amine means an amine having at least two primary and/or secondary amino groups in one molecule thereof. Examples thereof include aromatic polyfunctional amines such as phenylenediamine where two amino groups are bonded to benzene with any positional relation of ortho-, meta-, or para-position, xylylenediamine, 1,3,5-triaminobenzene, 1,2,4-triaminobenzene, benzidine, methylene-bis-dianiline, 4,4′-diaminobiphenyl ether, dianisidine, 3,3′,4-triaminobiphenyl ether, 3,3′,4,4′-tetraminobiphenyl ether, 3,3′-dioxybenzidine, 1,8-naphthalenediamine, m(p)-monomethylphenylenediamine, 3,3′-monomethylamino-4,4′-diaminobiphenyl ether, 4,N,N′-(4-aminobenzoyl)-p(m)-phenylenediamine-2,2′-bis(4-aminophenylbenzimidazole), 2,2′-bis(4-aminophenylbenzoxazole), 2,2′-(4-aminophenylbenzothiazole), and 3,5-diaminobenzoic acid, aliphatic amines such as ethylenediamine and propylenediamine, alicyclic polyfunctional amines such as 1,2-diaminocyclohexane, 1,4-diaminocyclohexane, piperazine, 2,5-dimethylpiperazine, 2-methylpiperazine, 2,6-dimethylpiperazine, 2,3,5-trimethylpiperazine, 2,5-diethylpiperazine, 2,3,5-triethylpiperazine, 2-n-propylpiperazine, 2,5-di-n-butylpiperazine, 1,3-bispiperidylpropane, and 4-aminomethylpiperazine. Of these, in consideration of selective separation ability, permeability, and heat resistance, the amine is preferably an aliphatic polyfunctional amine having two to four primary and/or secondary amino groups in one molecule. Particularly, more preferred is use of piperazine or 2,5-dimethylpiperazine capable of obtaining a nanofiltration membrane having higher solute-removing performance and water permeation performance in a wide composition ratio. These polyfunctional amines may be used singly or as a mixture.

In the case of the aromatic polyamide, preferred is one containing o-aromatic diamine having two amino groups at the ortho (o-) position, which is an amine having two or more amino groups in one molecule thereof, as the polyfunctional amine.

Furthermore, it is also preferred to contain at least one selected from the group consisting of an m-aromatic diamine having two amino groups at the meta (m-) position, a p-aromatic diamine having two amino groups at the para (p-) position, and aliphatic amines and derivatives thereof, particularly an m-aromatic diamine and/or a p-aromatic diamine with which a membrane excellent in potential of blocking performance and water permeation performance owing to a dense and rigid structure and further excellent in durability, especially heat resistance is easily obtained, as the polyfunctional amine.

Here, preferably used as the o-aromatic diamine is o-phenylenediamine. As the m-aromatic diamine, m-phenylenediamine is preferred but 3,5-diaminobenzoic acid, 2,6-diaminopyridine, or the like can be also used. As the p-aromatic diamine, p-phenylenediamine is preferred but 2,5-diaminobenzenesulfonic acid, p-xylylenediamine, or the like can be also used.

As the molar ratio of each of these polyfunctional amines in a membrane-forming raw solution, the most suitable composition ratio can be appropriately selected depending on the amine(s) and acid halide(s) to be used but water permeability is enhanced when the ratio of the o-aromatic diamine to be added increases, while the performance of blocking the whole solute decreases. Moreover, when the aliphatic polyfunctional amine is used in larger amount, the performance of separating multivalent ions from monovalent ions is enhanced, whereby it becomes possible to obtain the liquid separation membrane of the invention which satisfies objective water permeation performance and ion separation performance and the performance of blocking the whole solute.

The polyfunctional acid halide is not particularly limited so long as it is an acid halide having at least two halogenated carbonyl groups in one molecule thereof or a polyfunctional acid anhydride halide and forms a separation-functional layer of a crosslinked polyamide by the reaction with the above polyfunctional amine(s). Examples of trifunctional acid halide include trimesic acid chloride, 1,3,5-cyclohexanetricarboxylic acid trichloride, 1,2,4-cyclobutanetricarboxylic acid trichloride, and the like. Examples of bifunctional acid halide include aromatic bifunctional acid halides such as biphenyldicarboxylic acid dichloride, biphenylenecarboxylic acid dichloride, azobenzenedicarboxylic acid dichloride, terephthalic acid chloride, isophthalic acid chloride, and naphthalenedicarboxylic acid chloride, aliphatic bifunctional acid halides such as adipoyl chloride and sebacoyl chloride, alicyclic bifunctional acid halides such as cyclopentanedicarboxylic acid dichloride, cyclohexanedicarboxylic acid dichloride, and tetrahydrofuranedicarboxylic acid dichloride. When the reactivity with the polyfunctional amine is considered, the polyfunctional acid halide is preferably a polyfunctional acid chloride. Also, when the selective separation ability and heat resistance of the membrane are considered, preferred is a polyfunctional aromatic acid chloride having two to four chlorinated carbonyl groups in one molecule thereof. In particular, from the viewpoint of easy availability and easy handling, it is more preferred to use trimesic acid chloride. These polyfunctional acid halides may be used singly or as a mixture.

Moreover, as the polyfunctional acid anhydride halide, a trimellitic acid anhydride halide represented by the following general formula [III], which has one or more acid anhydride portions and one or more halogenated carbonyl groups and is a carbonyl halide of benzoic anhydride and phthalic anhydride, and derivatives thereof are preferably used.

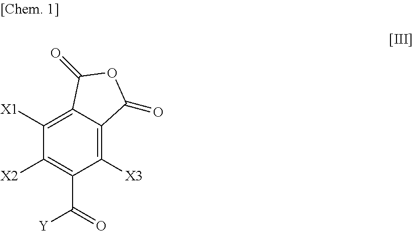

In the formula [III], X1 and X2 are selected from any of C1 to C3 linear or cyclic saturated or unsaturated aliphatic groups, H, OH, COOH, SO₃H, COF, COCl, COBr, and COI or an acid anhydride may be formed between X1 and X2. X3 is selected from any of C1 to C3 linear or cyclic saturated or unsaturated aliphatic groups, H, OH, COOH, SO₃H, COF, COCl, COBr, and COI. Y is selected from H, F, Cl, Br, I, or C1 to C3 hydrocarbons.

On the other hand, for example, when the alkali metal ions are permeated through the nanofiltration membrane in a corresponding amount of 50000 ppm or more to 100000 ppm or less as sodium ion, the separation of the alkali metal salts from the purification-inhibiting substances is preferably achieved at a high efficiency. That is, it is considered that an activity coefficient decreases under high salt concentration conditions and further an effect of size separation highly contributes also at the separation of inorganic salts as compared with charge repulsion and affinity to the membrane, although the mechanism is not thoroughly elucidated, under conditions where a masking effect of high-concentration ions against a charged membrane works. In addition, lithium concentration in permeate through the nanofiltration membrane becomes possible and thus the case is preferred. Surprisingly, it has been found that active transportation of easily permeable substances toward a permeation side occurs due to a concentration polarization effect on the separation membrane surface under specific concentration conditions.

At the filtration through the nanofiltration membrane, the above aqueous alkali metal salt solution is preferably supplied to the nanofiltration membrane in the pressure range of 0.1 MPa or more to 8 MPa or less. When the pressure is lower than 0.1 MPa, the membrane permeation rate decreases and when the pressure is higher than 8 MPa, an influence may be exerted on damage of the membrane. Moreover, when the solution is supplied at a pressure of 0.5 MPa or more to 6 MPa or less, the aqueous metal salt solution can be efficiently permeated because of a high membrane permeation flux and also a possibility of exerting an influence on the damage of the membrane is small, so that the case is preferred. The feeding at a pressure of 1 MPa or more to 4 MPa or less is particularly preferred. Furthermore, in the filtration using a nanofiltration membrane, the possibility of exerting an influence on the damage of the membrane is further decreased by performing the permeation at a pressure lower than the osmotic pressure of the aqueous alkali metal salt solution.

Furthermore, so as to achieve a metal salt ingredient ratio suitable for the subsequent step of obtaining the purified alkali metal salt(s) by concentration or the like, it is preferred to mix a part of the aqueous alkali metal salt solution with the permeated water formed by the treatment step of removing the purification-inhibiting substances with the separation membrane.

### EXAMPLES

The following will describe the invention with reference to Examples but the invention is not limited to these Examples. Measurements in Examples and Comparative Examples were performed as follows.

### (Isopropyl Alcohol Removal Ratio)

Evaluation was performed by comparing the isopropyl alcohol concentration in permeated water and that in supplying water when a 1000 ppm aqueous isopropyl alcohol solution adjusted to a temperature of 25° C. and pH of 6.5 was supplied to a separation membrane at an operation pressure of 0.75 MPa. Namely, the ratio was calculated as follows: Isopropyl alcohol removal ratio (%)=100×(1-(isopropyl alcohol concentration in permeated water/isopropyl alcohol concentration in supplying water)). In this regard, the isopropyl alcohol concentration was determined by a gas chromatograph (GC-18A manufactured by Shimadzu Corporation).

### (Glucose Removal Ratio)

Evaluation was performed by comparing the glucose concentration in permeated water and that in supplying water when a 1000 ppm aqueous glucose solution adjusted to a temperature of 25° C. and pH of 6.5 was supplied to a separation membrane at an operation pressure of 0.75 MPa. Namely, the ratio was calculated as follows: Glucose removal ratio (%)=100×(1−(glucose concentration in permeated water/glucose concentration in supplying water)). In this regard, the glucose concentration was determined by a refractometer (RID-6A manufactured by Shimadzu Corporation).

### (Preparation of Brine)

Two kinds of aqueous solutions containing various metal salts were prepared under the following conditions.

As a brine A, lithium chloride (4.3 g), sodium chloride (52.3 g), sodium tetraborate (10.4 g), sodium sulfate (25.3 g), potassium chloride (61.0 g), magnesium chloride (51.0 g), and calcium chloride (2.0 g) were each added to 1 L of pure water and dissolved with stirring at 25° C. for 8 hours. The solution was filtrated (No. 2 filter paper) and concentrations of various ions in the resulting solution were quantitatively determined by ion chromatographic measurement and were as shown in Table 1.

As a brine B, lithium chloride (2.1 g), sodium chloride (46.5 g), sodium tetraborate (5.2 g), sodium sulfate (12.6 g), potassium chloride (30.5 g), magnesium chloride (25.5 g), and calcium chloride (1.0 g) were each added to 1 L of pure water and dissolved with stirring at 25° C. for 8 hours. The pH was adjusted with hydrochloric acid. The solution was filtrated (No. 2 filter paper) and concentrations of various ions in the resulting solution were quantitatively determined by ion chromatographic measurement and were as shown in Table 1.

### (Ion Removal Ratio)

The salt concentration of permeated water when each of the above brines adjusted to a temperature of 25° C. was supplied to a semi-permeable membrane at an operation pressure of 2.0 MPa was determined by ion chromatographic measurement based on the following equation.

Ion removal ratio=100×{1−(salt concentration in permeated water/salt concentration in supplying water)}

### (Membrane Permeation Flux)

Using each of the above brines as supplying water, the membrane permeation flux (m³/m²/day) was determined based on the amount (cubic meter) of water permeated per square meter of the membrane surface per day.

### (Preparation of Microporous Supporting Membrane)

A 15.0% by weight of dimethylformamide (DMF) solution of polysulfone was cast on a nonwoven fabric (air permeability: 0.5 to 1 cc/cm²/sec) composed of a polyester fiber at a thickness of 180 μm at room temperature (25° C.) and the resulting membrane was immediately immersed in pure water and allowed to stand for 5 minutes, whereby a microporous supporting membrane (thickness: 150 to 160 μm) composed of a fiber-reinforced polysulfone supporting membrane was prepared.

### (Preparation of Separation Membrane A)

The microporous supporting membrane was immersed for 2 minutes in an aqueous solution containing a polyfunctional amine prepared so that the molar ratio of metaphenylenediamine to 1,3,5-triaminobenzene was 70/30 in an amount of 1.5% by weight as the whole polyfunctional amine and 3.0% by weight of c-caprolactam, and then the supporting membrane was gradually lifted up in a vertical direction. After excessive aqueous solution was removed from the supporting membrane surface by nitrogen blowing from an air nozzle, an n-decane solution containing 0.05% by weight of trimesic acid chloride was applied so that the surface was completely wetted, followed by standing for 1 minute. Then, in order to remove excessive solution from the membrane, the membrane was held vertically for 2 minutes to drain the solution and dried by gas blowing at 20° C. using an air blower. After the thus obtained separation membrane was treated with an aqueous solution containing 0.7% by weight of sodium nitrite and 0.1% by weight of sulfuric acid at room temperature for 2 minutes, the membrane was immediately washed with water and stored at room temperature to obtain a separation membrane A.

### (Preparation of Separation Membrane B)

The microporous supporting membrane was immersed for 2 minutes in an aqueous solution containing 0.25% by weight of piperazine, and the supporting membrane was gradually lifted up in a vertical direction. After excessive aqueous solution was removed from the supporting membrane surface by nitrogen blowing from an air nozzle, an n-decane solution containing 0.17% by weight of trimesic acid chloride was applied in a ratio of 160 cm³/m² so that the surface was completely wetted, followed by standing for 1 minute. Then, in order to remove excessive solution from the membrane, the membrane was held vertically for 1 minute to drain the solution and dried by gas blowing at 20° C. using an air blower. After drying, the membrane was immediately washed with water and stored at room temperature to obtain a separation membrane B.

### (Preparation of Separation Membrane C)

The microporous supporting membrane was immersed for 2 minutes in an aqueous solution containing 1.0% by weight of piperazine, 1.5% by weight of trisodium phosphate dodecahydrate, and 0.5% by weight of sodium dodecyl sulfate, and the supporting membrane was gradually lifted up in a vertical direction. After excessive aqueous solution was removed from the supporting membrane surface by nitrogen blowing from an air nozzle, an n-decane solution containing 0.2% by weight of trimesic acid chloride was applied in a ratio of 160 cm³/m² so that the surface was completely wetted, followed by standing for 1 minute. Then, in order to remove excessive solution from the membrane, the membrane was held vertically for 1 minute to drain the solution and dried by gas blowing at 20° C. using an air blower. After drying, the membrane was immediately washed with water and stored at room temperature to obtain a separation membrane C.

### (Preparation of Separation Membrane D)

After SCL-100 (a cellulose acetate reverse osmosis membrane manufactured by Toray Industries, Inc.) was treated at room temperature for 24 hours with a 0.1% by weight aqueous sodium hypochlorite solution adjusted to pH 9, the membrane was immediately washed with water and stored at room temperature to obtain a separation membrane D.

### Example 1

Using UTC-60 (a crosslinked aromatic polyamide nanofiltration membrane manufactured by Toray Industries, Inc.) as a separation membrane, the ion removal ratio and water permeation performance were evaluated using each of the brines A and B as a raw water. The results are shown in Table 1 together with the isopropyl alcohol removal ratio and the glucose removal ratio.

### Comparative Example 1

Evaluation was performed in the same manner as in Example 1 except that the separation membrane A is used as a separation membrane. The results are shown in Table 1.

### Example 2

Evaluation was performed in the same manner as in Example 1 except that the separation membrane B is used as a separation membrane. The results are shown in Table 1.

### Example 3

Evaluation was performed in the same manner as in Example 1 except that the separation membrane C is used as a separation membrane. The results are shown in Table 1.

### Comparative Example 2

Evaluation was performed in the same manner as in Example 1 except that the separation membrane D is used as a separation membrane. The results are shown in Table 1.

As seen in the results shown in Table 1, it was apparent that a glucose removal ratio of 90% or more is necessary for exhibiting the blocking ability against ions such as magnesium ion and sulfate ion which are to be purification-inhibiting substances and also the difference between the glucose removal ratio and the isopropyl alcohol removal ratio is necessarily 30% or more from the consideration of a balance between an appropriate amount of water permeated and a selective permeation property (Mg/Li ratio).

TABLE 1

| | | | | Comparative | | | Comparative |
|---|---|---|---|---|---|---|---|
| | | | Example 1 | Example 1 | Example 2 | Example 3 | Example 2 |
| Isopropyl alcohol removal ratio (%) | | | 35 | 71 | 31 | 45 | 5 |
| Glucose removal ratio (%) | | | 95 | 99 | 94 | 90 | 83 |
| | | | Removal | Removal | Removal | Removal | Removal |
| | Ion | | ratio | ratio | ratio | ratio | ratio |
| | concentration | ppm | % | % | % | % | % |
| Brine | Li⁺ | 210 | 4.2 | 47.7 | 3.0 | 11.1 | 2.3 |
| A | Na⁺ | 6500 | 13.8 | 42.9 | 14.5 | 16.0 | 0.6 |
| | K⁺ | 8700 | 15.3 | 37.9 | 18.5 | 15.8 | 9.1 |
| | Mg²⁺ | 4500 | 93.6 | 94.5 | 95.9 | 66.0 | 8.5 |
| | Ca²⁺ | 440 | 86.4 | 94.1 | 91.1 | 62.6 | 7.6 |
| | SO₄²⁻ | 5900 | 99.9 | 97.3 | 99.4 | 98.7 | 5.2 |
| | Cl⁻ | 48000 | 30.0 | 53.4 | 32.4 | 19.4 | 3.6 |
| | Mg/Li | 21.4 | 1.5 | 2.3 | 0.9 | 8.3 | 20.1 |
| | Amount of water | | 0.78 | 0.06 | 0.54 | 1.44 | 0.88 |
| | permeated (m³/m²/day) | | | | | | |
| Brine | Li⁺ | 460 | −18.0 | 74.2 | −23.5 | −13.3 | 1.6 |
| B | Na⁺ | 24000 | 2.9 | 76.7 | −1.7 | 5.3 | 2.1 |
| | K⁺ | 25000 | 5.7 | 75.9 | 2.6 | 7.1 | 2.3 |
| | Mg²⁺ | 14000 | 87.5 | 96.0 | 91.9 | 78.2 | 3.1 |
| | Ca²⁺ | 2600 | 87.5 | 96.6 | 90.4 | 83.0 | 9.8 |
| | SO₄²⁻ | 15000 | 99.8 | 98.3 | 99.6 | 98.6 | 2.2 |
| | Cl⁻ | 132000 | 57.0 | 90.8 | 74.7 | 62.0 | 3.3 |
| | Mg/Li | 30.4 | 3.1 | 4.6 | 1.9 | 5.7 | 30.0 |

| | | | | | |
|---|---|---|---|---|---|
| Amount of water | 0.21 | >0.01 | 0.12 | 0.36 | 0.76 |
| permeated (m³/m²/day) | | | | | |

Note:
the case where the removal ratio was shown as a negative value means that the ion was enriched.

While the invention has been described in detail and with reference to specific embodiments thereof, it will be apparent to one skilled in the art that various changes and modifications can be made therein without departing from the spirit and scope of the invention.

This application is based on Japanese Patent Application No. 2010-268014 filed on Dec. 1, 2010, the entire contents of which are incorporated herein by reference.

### INDUSTRIAL APPLICABILITY

The present invention can be suitably utilized as a method for efficient separation and recovery of alkali metals such as lithium and potassium from lake water, ground water, industrial waste water, and the like.

1. A method for separating and recovering a purified alkali metal salt from an aqueous alkali metal salt solution, the method comprising a treatment step of removing a purification-inhibiting substance from an aqueous alkali metal salt solution with a separation membrane having a glucose removal ratio and an isopropyl alcohol removal ratio simultaneously satisfying the following expressions (I) and (II) when each of a 1000 ppm aqueous glucose solution having a temperature of 25° C. and pH of 6.5 and a 1000 ppm aqueous isopropyl alcohol solution having a temperature of 25° C. and pH of 6.5 is permeated through the separation membrane at an operating pressure of 0.75 MPa:
Glucose removal ratio≧90% (I),
Glucose removal ratio−Isopropyl alcohol removal ratio≧30% (II).

2. The method for separating and recovering a purified alkali metal salt according to claim 1, wherein a lithium ion concentration in the aqueous alkali metal salt solution falls within the range of 0.5 ppm or more to 10000 ppm or less.

3. The method for separating and recovering a purified alkali metal salt according to claim 1, wherein a magnesium ion concentration in the aqueous alkali metal salt solution is 1000 times or less the lithium ion concentration.

4. The method for separating and recovering of a purified alkali metal salt according to claim 1, which includes a step of mixing a part of the aqueous alkali metal salt solution with a permeated water formed by the treatment step.

5. The method for separating and recovering a purified alkali metal salt according to claim 1, wherein the purification-inhibiting substance in the aqueous alkali metal salt solution is removed and also lithium is enriched by the treatment step.

6. The method for separating and recovering a purified alkali metal salt according to claim 1, wherein a concentration treatment of the alkali metal salt is performed after the treatment step.

7. The method for separating and recovering a purified alkali metal salt according to claim 1, wherein the treatment step is performed until the magnesium ion concentration in the aqueous alkali metal salt solution becomes 7 times or less the lithium ion concentration.

8. The method for separating and recovering a purified alkali metal salt according to claim 1, wherein the purification-inhibiting substance is at least one selected from the group consisting of a magnesium salt and a sulfate salt.

9. The method for separating and recovering a purified alkali metal salt according to claim 1, wherein an operation pressure of the membrane separation at the treatment step is osmotic pressure of the aqueous alkali metal salt solution or lower.
